(19) United States
(12) Patent Application Publication
(10) Pub. No.: US 2022/0381356 A1
(43) Pub. Date: Dec. 1, 2022

(54) CHECK VALVE, REFRIGERANT PIPING SYSTEM HAVING SAME, AND ASSEMBLING METHOD THEREOF

(71) Applicant: HS R & A Co.,Ltd., Gyeongsangnam-do (KR)

(72) Inventors: Kwon Sik HWANG, Gyeongsangnam-do (KR); Young Jun KIM, Gyeongsangnam-do (KR); Seung Hoon SUNG, Busan (KR); Jae Hyeok CHOI, Gyeongsangnam-do (KR)

(73) Assignee: HS R & A Co.,Ltd., Gyeongsangnam-do (KR)

(21) Appl. No.: 17/579,214

(22) Filed: Jan. 19, 2022

(30) Foreign Application Priority Data
May 31, 2021 (KR) 10-2021-0070014

(51) Int. Cl. F16K 15/02; F25B 41/20

(52) U.S. Cl. CPC F16K 15/023; F25B 41/20

(57) ABSTRACT

A check valve is provided in a refrigerant piping line of a refrigerant piping system to restrict a flow direction of refrigerant. The check value includes a valve body movably disposed inside the refrigerant piping line in a longitudinal direction of the refrigerant piping line, a stopper coupled to a rear end of the valve body to limit a movement of the valve body, and an elastic member disposed between the valve body and the stopper and providing an elastic force to the valve body. The valve body may have at least one locking protrusion formed at the rear end thereof, and the stopper may have a corresponding locking slit. The locking protrusion may pass through the locking slit and then rotate relatively whereby the stopper can be fixed to the valve body.

### CROSS-REFERENCE TO RELATED APPLICATION(S)

This application is based on and claims priority under 35 U.S.C. § 119 to Korean Patent Application No. 10-2021-0070014, filed on May 31, 2021, in the Korean Intellectual Property Office, the entire disclosure of which is herein incorporated by reference.

### BACKGROUND OF THE INVENTION

### Field of the Invention

The disclosure relates to a check valve, a refrigerant piping system having the check valve, and an assembling method of the refrigerant piping system. Particularly, the disclosure relates to a check valve integrally assembled with a refrigerant piping line of a refrigerant piping system to improve the assembling property of the refrigerant piping system, and also relates to the refrigerant piping system having the check valve, and an assembling method of the refrigerant piping system.

### Description of Related Art

Automotive air conditioning equipment is vehicle internal equipment installed to cool or heat the interior of a vehicle in summer or winter or to remove frost stuck on a windshield in rain or winter for the purpose of allowing the driver to secure front and rear views. The automotive air conditioning equipment, generally including both a heating system and a cooling system, selectively introduces outside or inside air, heats or cools the air, and then blows it into the interior of the vehicle, thereby cooling, heating, or ventilating the vehicle interior.

As shown in FIG. 1, the cooling system of the automotive air conditioning equipment is constituted such that a compressor 1, a condenser 2, an expansion valve 3, an evaporator 4, and the like are interconnected by a refrigerant piping line of a refrigerant piping system 10 composed of a plurality of refrigerant pipes. In the cooling system, the compressor 1 compresses and sends out refrigerant, and the condenser 2 condenses the high-pressure refrigerant sent from the compressor 1. In addition, the expansion valve 3 throttles the refrigerant condensed and liquefied in the condenser 2, and the evaporator 4 evaporates the low-pressure liquid refrigerant throttled by the expansion valve 3 through heat exchange with air blown into the vehicle interior and thereby cools the air discharged into the vehicle interior by the endothermic action of the evaporation latent heat of the refrigerant.

Meanwhile, in the refrigerant piping line of the refrigerant piping system 10 connecting the compressor 1 and the condenser 2, a check valve 20 for allowing the refrigerant to flow in one direction and preventing movement in the opposite direction is installed.

FIG. 2 is an exploded perspective view illustrating components of a conventional check valve, and FIG. 3 is a diagram illustrating the structure of a check valve included in a conventional refrigerant piping system.

With reference to FIGS. 2 and 3, the conventional check valve 20 includes a valve body 21 disposed in the refrigerant piping line, a supporter 22 coupled to one end of the valve body 21, and an elastic member 23 disposed between the valve body 21 and the supporter 22.

In addition, the refrigerant piping line is equipped with a mounting pipe 13 in which the above-described components of the check valve 20 are disposed. Also, a compressor-side refrigerant pipe 11 and a condenser-side refrigerant pipe 12 are connected to both sides of the mounting pipe 13, respectively, via welding.

However, the conventional check valve 20 is not a structure that the respective components are assembled and formed integrally, so each component of the check valve 20 should be inserted and arranged individually inside the mounting pipe 13. This results in a problem that the assembly property is deteriorated.

In addition, as the compressor-side refrigerant pipe 11 and the condenser-side refrigerant pipe 12 are connected to both sides of the mounting pipe 13, respectively, via welding, there is a problem in that the work process and manufacturing cost increase.

### SUMMARY OF THE INVENTION

The disclosure provides a check valve integrally assembled with a refrigerant piping line of a refrigerant piping system to improve the assembling property of the refrigerant piping system, and also provides the refrigerant piping system having the check valve, and an assembling method of the refrigerant piping system.

According to an embodiment of the disclosure, a check valve is provided in a refrigerant piping line of a refrigerant piping system to restrict a flow direction of refrigerant, and the check value may include a valve body movably disposed inside the refrigerant piping line in a longitudinal direction of the refrigerant piping line, a stopper coupled to a rear end of the valve body to limit a movement of the valve body, and an elastic member disposed between the valve body and the stopper and providing an elastic force to the valve body. The valve body may have at least one locking protrusion formed at the rear end thereof, and the stopper may have a corresponding locking slit. The locking protrusion may pass through the locking slit and then rotate relatively whereby the stopper can be fixed to the valve body.

According to an embodiment of the disclosure, a refrigerant piping system may include a refrigerant piping line including a plurality of refrigerant pipes for interconnecting a compressor, a condenser, an expansion valve, and an evaporator constituting a cooling system, and a check valve provided in the refrigerant piping line to limit a movement direction of refrigerant. The plurality of refrigerant pipes may include a first refrigerant pipe connected to the compressor, an expanded pipe formed to extend from one end of the first refrigerant pipe, and a second refrigerant pipe having one side connected to the condenser and other side inserted into and fixed to one side of the expanded pipe. The check valve may be disposed inside the expanded pipe and restrict a flow direction of refrigerant. The check valve may include a valve body movably disposed inside the expanded pipe in a longitudinal direction of the refrigerant piping line, a stopper coupled to a rear end of the valve body to limit a movement of the valve body, and an elastic member disposed between the valve body and the stopper and providing an elastic force to the valve body. The valve body may have at least one locking protrusion formed at the rear end thereof, and the stopper may have a corresponding locking slit. The locking protrusion may pass through the locking slit and then rotate relatively whereby the stopper can be fixed to the valve body.

According to an embodiment of the disclosure, a method for assembling a refrigerant piping system including a first refrigerant pipe connected to a compressor, an expanded pipe formed to extend from one end of the first refrigerant pipe, and a second refrigerant pipe having one side connected to a condenser and other side inserted into and fixed to one side of the expanded pipe may include assembling a check valve including a valve body, a stopper coupled to a rear end of the valve body, and an elastic member disposed between the valve body and the stopper, disposing the check valve inside the expanded pipe, inserting and coupling one side of the second refrigerant pipe into and to one side of the expanded pipe in which the check valve is disposed, and fixing the one side of the second refrigerant pipe and the one side of the expanded pipe by welding.

According to the disclosure, by installing the integrally assembled check valve in the refrigerant piping line of the refrigerant piping system, it is possible to improve the assembly property of the refrigerant piping system.

In addition, according to the disclosure, only the second refrigerant pipe is connected to the expanded pipe, so that the working process and manufacturing cost can be reduced as much as possible.

In addition, according to the disclosure, there is no need for a separate constitution for fixing the stopper of the check valve inside the expanded pipe, so that the structure of the refrigerant piping system can be simplified.

In addition, according to the disclosure, the sealing member is provided on the check valve, so it is possible to prevent refrigerant leakage and reduce noise as much as possible.

### BRIEF DESCRIPTION OF THE DRAWINGS

FIG. 1 is a diagram schematically illustrating the structure of a cooling system connected by a conventional refrigerant piping system.

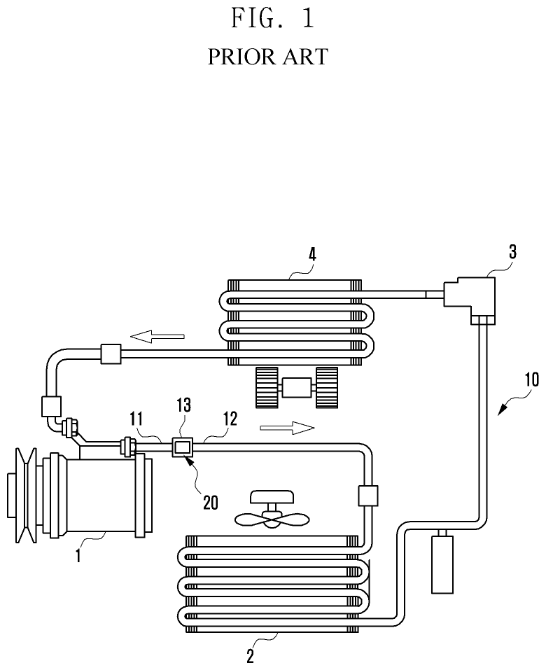

FIG. 2 is an exploded perspective view illustrating components of a conventional check valve.

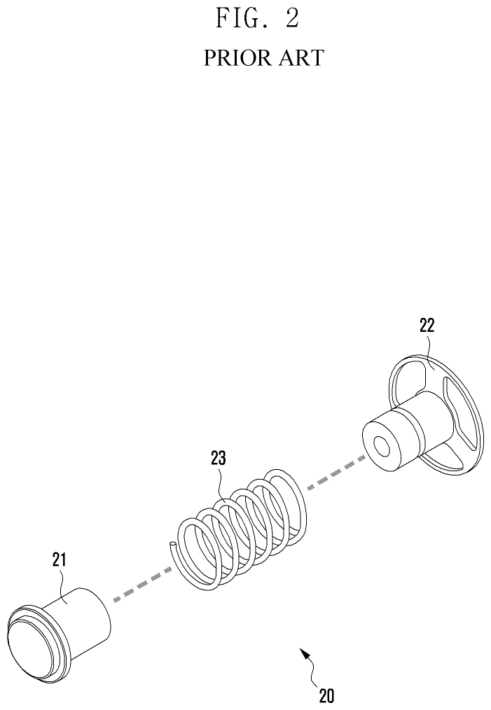

FIG. 3 is a diagram illustrating the structure of a check valve included in a conventional refrigerant piping system.

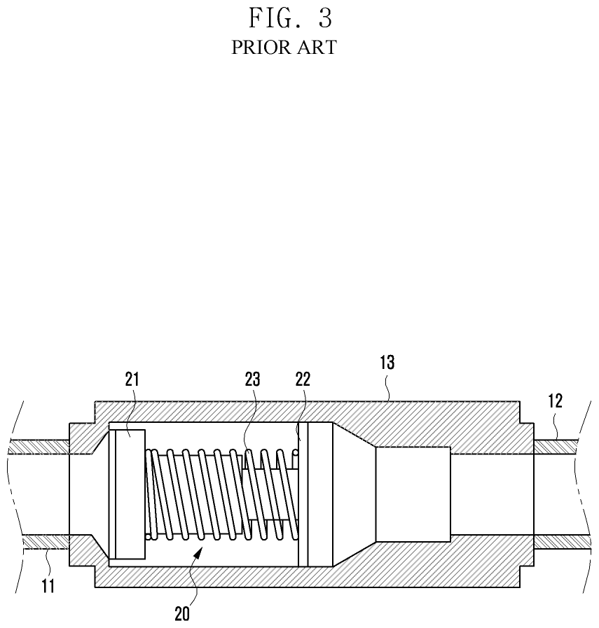

FIG. 4 is a diagram schematically illustrating the structure of a cooling system connected by a refrigerant piping system according to an embodiment of the disclosure.

FIG. 5 is a perspective view illustrating the structure of a check valve to be used with the cooling system and the refrigerant piping system of FIG. 4 according to an embodiment of the disclosure.

FIG. 6 is a cross-sectional view schematically illustrating the structure of the check valve of FIG. 5.

FIG. 7 is an exploded perspective view illustrating components of the check valve of FIG. 5.

FIGS. 8a-b are diagrams schematically illustrating a possible operation of a stopper of the check valve of FIGS. 5-7 according to an embodiment of the disclosure.

FIG. 9 is a diagram illustrating a state of the check valve of FIGS. 5-8 before operation according to an embodiment of the disclosure.

FIG. 10 is a diagram schematically illustrating an operating state of the check valve of FIGS. 5-8 according to an embodiment of the disclosure.

FIG. 11 is a flow diagram illustrating a method of assembling the refrigerant piping system of FIG. 4 according to an embodiment of the disclosure.

### DETAILED DESCRIPTION

Hereinafter, embodiments of the disclosure will be described in detail with reference to the accompanying drawings. It should be noted that, in the accompanying drawings, the same elements are denoted by the same reference numerals. In addition, detailed descriptions of well-known functions and configurations that may obscure the gist of the disclosure will be omitted.

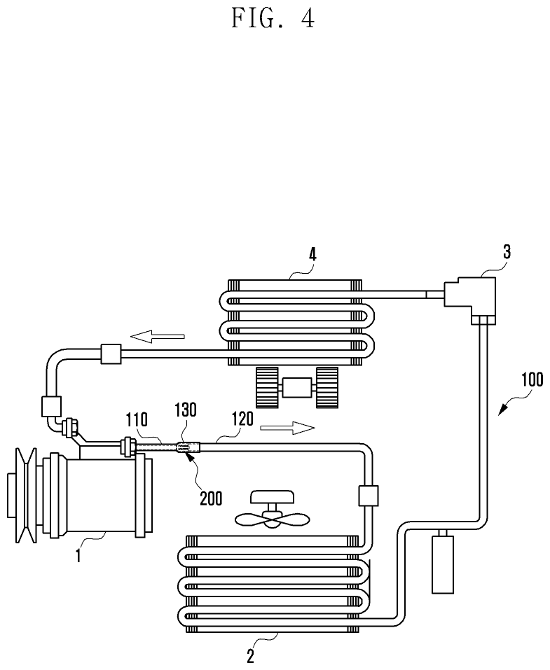

Now, an embodiment of the disclosure will be described with reference to FIGS. 4 to 11.

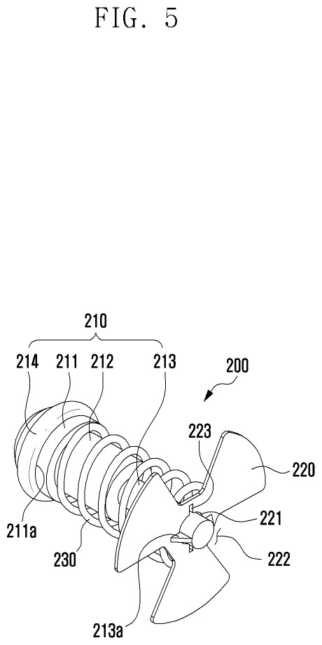

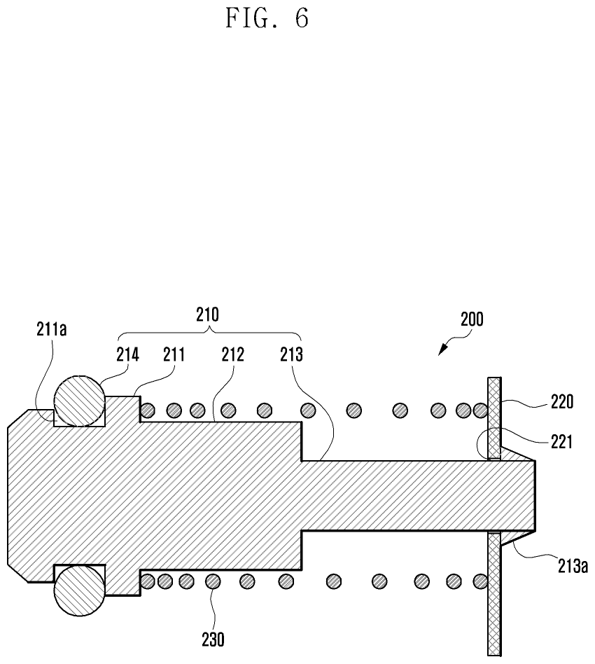

FIG. 4 is a diagram schematically illustrating the structure of a cooling system connected by a refrigerant piping system according to an embodiment of the disclosure, FIG. 5 is a perspective view illustrating the structure of a check valve according to an embodiment of the disclosure, and FIG. 6 is a cross-sectional view schematically illustrating the structure of a check valve according to an embodiment of the disclosure.

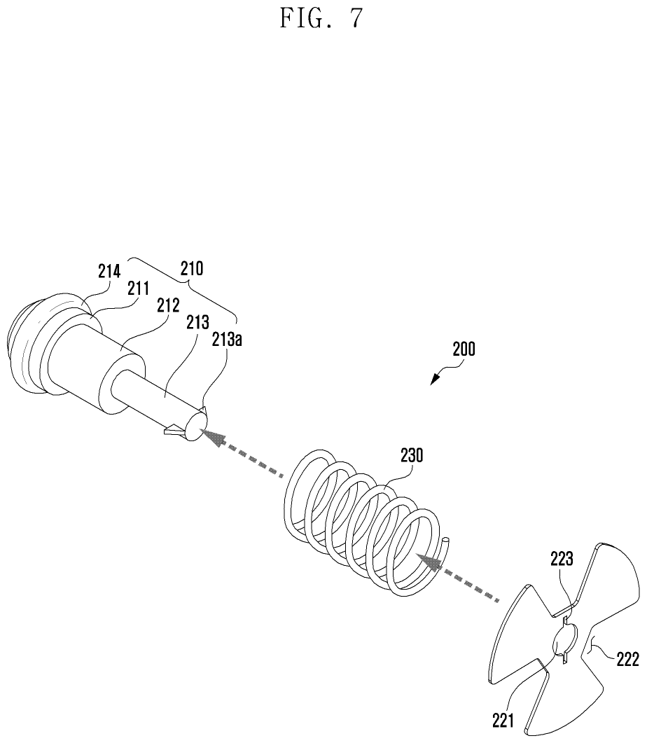

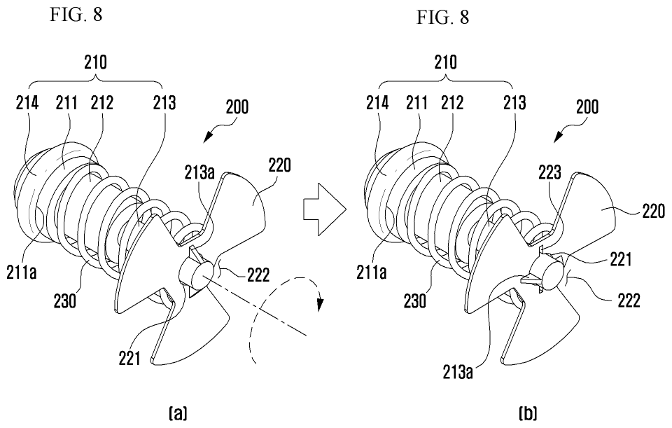

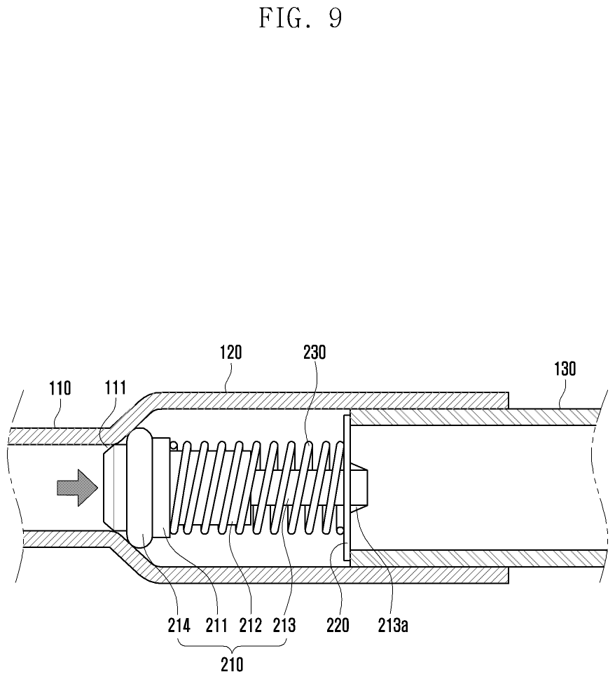

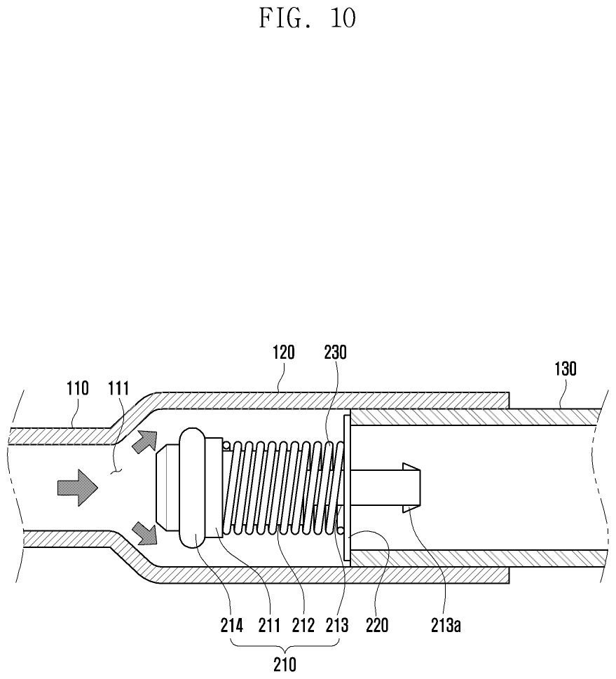

In addition, FIG. 7 is an exploded perspective view illustrating components of a check valve according to an embodiment of the disclosure, and FIG. 8 is a diagram schematically illustrating an operation of a stopper according to an embodiment of the disclosure. FIG. 9 is a diagram illustrating a state of check valve before operation according to an embodiment of the disclosure, and FIG. 10 is a diagram schematically illustrating an operating state of a check valve according to an embodiment of the disclosure.

With reference to FIG. 4, the refrigerant piping system 100 according to the disclosure may include a refrigerant piping line composed of a plurality of refrigerant pipes for interconnecting the compressor 1, the condenser 2, the expansion valve 3, and the evaporator 4 constituting the vehicle cooling system.

The refrigerant piping line may include an expanded pipe 120 formed by expanding at least one of the plurality of refrigerant pipes. A check valve 200 to be described later may be provided inside the expanded pipe 120.

For example, the expanded pipe 120 provided with the check valve 200 may be formed to be expanded while extending from one side of a first refrigerant pipe 110 connected to the compressor 1. In addition, one side of a second refrigerant pipe 130 connected to the condenser 2 may be fixedly inserted into one side of the expanded pipe 120 to be connected to the first refrigerant pipe 110.

The check valve 200 provided in the expanded pipe 120 may restrict a flow direction of refrigerant flowing through the first refrigerant pipe 110 to only one direction (e.g., a direction toward the condenser).

Hereinafter, the configuration and operation of the check valve 200 according to an embodiment of the disclosure will be described in detail with reference to FIGS. 5 to 10.

As shown in FIGS. 5 to 8, the check valve 200 according to an embodiment of the disclosure includes a valve body 210, a stopper 220, and an elastic member 230.

The valve body 210 may be movably disposed inside the above-described expanded pipe 120. The valve body 210 may include a body part 211, a support part 212 for supporting the elastic member 230, and an extension part 213.

The body part 211 may restrict the flow direction of refrigerant flowing in the refrigerant pipe that connects the compressor 1 and the condenser 2. For example, the body part 211 is disposed at a connection portion between the first refrigerant pipe 110 and the expanded pipe 120 so that the front end of the body part 211 is in close contact with a discharge port 111 (see FIGS. 8 a-b and 9) of the first refrigerant pipe 110 to restrict the flow direction of refrigerant to only one direction. That is, the flow direction of refrigerant may be restricted to allow the refrigerant to flow from the first refrigerant pipe 110 to the expanded pipe 120 and prevent the refrigerant from flowing backward from the expanded pipe 120 toward the first refrigerant pipe 110.

The elastic member support part 212 may be formed to extend from one end of the body part 211 toward the flow direction of refrigerant (see arrow of FIG. 9), and may have a smaller diameter than the diameter of the body part 211. A part of the elastic member 230 may be disposed to be fitted to the elastic member support part 212, and the valve body 210 can move forward and backward inside the expanded pipe 120 by the elastic restoring force of the elastic member 230.

The extension part 213 may be formed to extend from one end of the elastic member support part 212 toward the flow direction of refrigerant. The extension part 213 may have a smaller diameter than the diameter of the elastic member support part 212. The extension part 213 is movably coupled to the stopper 220 to be described later and guides the movement of the valve body 210 inside the expanded pipe 120.

At one end of the extension part 213, at least one locking protrusion 213a may be provided. The at least one locking protrusion 213a may be coupled to a locking slit 223 formed in a central portion of the stopper 220 to lock the stopper 220.

For example, the locking protrusion 213a may be formed to protrude outwardly from the outer circumferential surface of the extension part 213. Although it is shown in this embodiment that two locking protrusions 213a are formed on the outer circumferential surface of the extension part 213, this is exemplary only and is not construed as a limitation of the disclosure. The operation of the locking protrusion 213a will be described later in detail while explaining the structure of the stopper 220.

The valve body 210 according to an embodiment of the disclosure may further include a sealing member 214 on the body part 211. The sealing member 214 can prevent refrigerant from leaking when the body part 211 is in close contact with the discharge port 111 of the first refrigerant pipe 110.

In addition, the sealing member 214 can minimize any impact or noise that may be caused when the body part 211 in movement strongly contacts the discharge port 111.

The material of the sealing member 214 may be, for example, but is not limited to, ethylene propylene diene monomer (EPDM).

In addition, the body part 211 may have a sealing member coupling groove 211a concavely formed on the outer circumferential surface thereof to accommodate the sealing member 214.

As shown in FIGS. 7 to 9, the stopper 220 according to an embodiment of the disclosure may be disposed inside the expanded pipe 120 and spaced apart from the valve body 210 at a predetermined distance. Also, the stopper 220 may be disposed to be coupled to the extension part 213 of the valve body 210.

Specifically, the stopper 220 may be formed in the shape of fan blades, and at least one refrigerant passage hole or opening 222 may be provided between the blades so that the refrigerant flowing through the expanded pipe 120 may pass. Although it is shown in this embodiment that three refrigerant passage holes or openings 222 are formed, this is exemplary only and is not construed as a limitation of the disclosure.

In the central portion of the stopper 220, a coupling hole 221 into which one end of the extension part 213 is inserted may be provided. Also, a locking slit 223 may be formed in the central portion of the stopper 220 to extend from one side of the coupling hole 221. The locking slit 223 may receive the locking protrusion 213a formed on the extension part 213.

That is, as shown in FIG. 8(a), after the locking protrusion 213a formed on the extension part 213 passes through the locking slit 223 formed in the stopper 220, the stopper 220 may be rotated in any one direction. Then, as shown in FIG. 8(b), the locking protrusion 213a is escaped from the locking slit 223 and becomes placed on the rear surface of the stopper 220. As such, when the locking protrusion 213a and the locking slit 223 are at different positions, the stopper 220 can be fixed to the extension part 213. As a result, all of the valve body 210, the elastic member 230, and the stopper 220 are assembled into an integral form.

The elastic member 230 according to an embodiment of the disclosure is disposed between the valve body 210 and the stopper 220. One end of the elastic member 230 may be coupled to the elastic member support part 212 of the valve body 210, and the other end may be in contact with the front surface of the stopper 220. The elastic member 230 provides an elastic force to the valve body 210.

Specifically, when the pressure of the refrigerant is applied, the valve body 210 compresses the elastic member 230 while moving in the expanded pipe 120 and opens the discharge port 111 of the first refrigerant pipe 110. When the pressure of the refrigerant is removed, the valve body 210 returns to the initial position by the elastic restoring force of the elastic member 230, and the main body 211 of the valve body 210 closes the discharge port 111 of the first refrigerant pipe 110.

With reference to FIGS. 9 and 10, when the cooling system according to an embodiment of the disclosure is in an operating state, the refrigerant begins to flow by the pressure of the compressor 1.

As shown in FIG. 9, the refrigerant discharged from the compressor 1 flows through the first refrigerant pipe 110 and pushes the valve body 210 of the check valve 200 that closes the discharge port 111 of the first refrigerant pipe 110. Then, as shown in FIG. 10, the valve body 210 moves in the refrigerant flow direction inside the expanded pipe 120 by the pressure of the refrigerant, and therefore the discharge port 111 of the first refrigerant pipe 110 becomes open. The refrigerant flows into the expanded pipe 120 through the discharge port 111, passes through the refrigerant passage hole 222 formed in the stopper 220, and moves to the second refrigerant pipe 130 to be supplied to the condenser 2.

On the other hand, when the operation of the cooling system is stopped, the operation of the compressor 1 is also stopped and the refrigerant is no longer moved. In this case, as shown in FIG. 9, the valve body 210 returns to the initial position by the elastic restoring force of the elastic member 230 and thereby closes the discharge port 111.

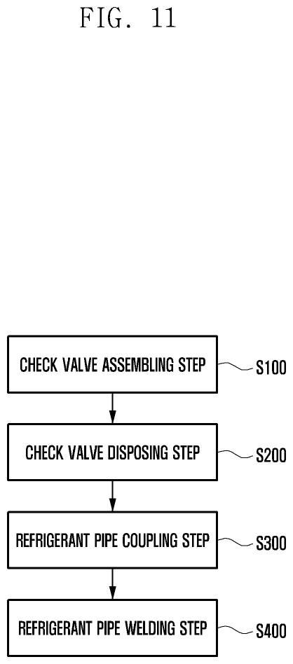

Now, an assembling method of the refrigerant piping system provided with the above-described check valve 200 according to an embodiment of the disclosure will be described in detail with reference to FIG. 11.

FIG. 11 is a flow diagram illustrating a method of assembling a refrigerant piping system according to an embodiment of the disclosure.

As shown in FIG. 11, the assembling method of the refrigerant piping system 100 according to an embodiment of the disclosure may include a check valve assembling step S100, a check valve disposing step S200, a refrigerant pipe coupling step S300, and a refrigerant pipe welding step S400.

At the check valve assembling step S100, respective components of the check valve 200 are assembled.

Specifically, at the check valve assembling step S100, the elastic member 230 is coupled to the elastic member support part 212 of the valve body 210, and then the stopper 220 is coupled to the extension part 213 of the valve body 210.

At this time, one end of the extension part 213 is inserted into the coupling hole 221 of the stopper 220, and simultaneously the locking protrusion 213a formed on the extension part 213 passes through the locking slit 223 formed in the stopper 220.

In this state, when the stopper 220 is rotated in any one direction, the locking protrusion 213a is escaped from the locking slit 223 and comes into contact with the rear surface of the stopper 220. At this time, because the elastic member 230 provides an elastic force to the stopper 220, the stopper 220 is fixed to the extension part 213. In addition, the sealing member 214 is coupled to the sealing member coupling groove 211a formed in the body part 211 of the valve body 210. When this process is completed, the check valve 200 is in an integrally assembled state.

Next, at the check valve disposing step S200, the integrally assembled check valve 200 is disposed inside the expanded pipe 120.

At this time, the front end of the body part 211 of the valve body 210 is disposed in close contact with the discharge port 111 of the first refrigerant pipe 110, and the remaining configuration of the check valve 200 is located inside the expanded pipe 120.

Next, at the refrigerant pipe coupling step S300, one side of the second refrigerant pipe 130 is inserted into and coupled to one side of the expanded pipe 120.

At this time, the second refrigerant pipe 130 inserted into the expanded pipe 120 comes into close contact with the rear surface of the stopper 220. That is, as one side of the second refrigerant pipe 130 is inserted into the expanded pipe 120 and supports the rear surface of the stopper 220, it is possible to restrict the movement of the stopper 220 inside the expanded pipe 120 without any separate configuration for limiting the movement of the stopper 220.

Next, at the refrigerant pipe welding step S400, a welding process for fixing the second refrigerant pipe 130 inserted into the expanded pipe 120 to the expanded pipe 120 is performed.

Through the assembling process as described above, it is possible to simply assemble the check valve in the expanded pipe of the refrigerant piping system.

According to the disclosure, by installing the integrally assembled check valve in the refrigerant piping line of the refrigerant piping system, it is possible to improve the assembly property of the refrigerant piping system.

In addition, according to the disclosure, only the second refrigerant pipe is connected to the expanded pipe, so that the working process and manufacturing cost can be reduced as much as possible.

In addition, according to the disclosure, there is no need for a separate configuration for fixing the stopper of the check valve inside the expanded pipe, so that the structure of the refrigerant piping system can be simplified.

In addition, according to the disclosure, the sealing member is provided on the check valve, so it is possible to prevent refrigerant leakage and reduce noise as much as possible.

While the disclosure has been particularly shown and described with reference to exemplary embodiments thereof, it will be understood by those skilled in the art that various changes in form and details may be made therein without departing from the scope of the subject matter as defined by the appended claims.

We claim:

1. A check valve provided in a refrigerant piping line of a refrigerant piping system to restrict a flow direction of refrigerant, the check valve comprising:
a valve body movably disposed inside a refrigerant piping line in a longitudinal direction of the refrigerant piping line;
a stopper coupled to a rear end of the valve body to limit movement of the valve body; and
an elastic member disposed between the valve body and the stopper and providing an elastic force to the valve body, wherein the valve body comprises a locking protrusion formed at the rear end of the valve body, and the stopper defines a corresponding locking slit, and wherein the locking protrusion passes through the locking slit and then rotates relative to the elastic member, wherein the stopper is fixed to the valve body.

2. The check valve of claim 1, wherein the valve body comprises:
a body part restricting a flow direction of refrigerant flowing in the refrigerant piping line;
an elastic member support part formed to extend from one end of the body part and supporting the elastic member; and
an extension part formed to extend from the elastic member support part and comprising an end movably coupled to the stopper, and
wherein the locking projection is formed to protrude outwardly from an outer circumferential surface of the end of the extension part.

3. The check valve of claim 2, wherein the elastic member support part has a diameter smaller than a diameter of the body part, and the extension part has a diameter smaller than the diameter of the elastic member support part.

4. The check valve of claim 2, wherein the stopper is formed in a shape of fan blades, wherein the check valve further comprises:
a refrigerant passage opening formed between the fan blades to allow the refrigerant to pass through the refrigerant passage opening; and
a coupling hole formed in a central portion of the stopper into which one end of the extension part is movably inserted, wherein the locking slit is formed to extend from the coupling hole.

5. The check valve of claim 2, wherein the valve body further comprises:
a sealing member coupled on the body part and preventing the refrigerant existing in the refrigerant piping line from leaking when the refrigerant piping line is closed by operation of the valve body, wherein the body part comprises a sealing member coupling groove concavely formed on an outer circumferential surface of the body part to accommodate the sealing member.

6. A refrigerant piping system comprising:
a refrigerant piping line comprising a plurality of refrigerant pipes for interconnecting a compressor, a condenser, an expansion valve, and an evaporator constituting a cooling system; and
a check valve provided in the refrigerant piping line to limit a flow direction of refrigerant, wherein the plurality of refrigerant pipes comprise:
a first refrigerant pipe connected to the compressor;
an expanded pipe formed to extend from one end of the first refrigerant pipe; and
a second refrigerant pipe comprising:
a first side connected to the condenser; and a second side inserted into and fixed to a side of the expanded pipe,
wherein the check valve is disposed inside the expanded pipe and restricts the flow direction of refrigerant, and
wherein the check value comprises:
a valve body movably disposed inside the expanded pipe in a longitudinal direction of the refrigerant piping line;
a stopper coupled to a rear end of the valve body to limit movement of the valve body; and
an elastic member disposed between the valve body and the stopper and providing an elastic force to the valve body; and
wherein the valve body comprises a locking protrusion formed at the rear end of the valve body, and the stopper comprising a corresponding locking slit, and wherein the locking protrusion passes through the locking slit and then rotates relative to the elastic member, wherein the stopper is fixed to the valve body.

7. The refrigerant piping system of claim 6, wherein the valve body comprises:
a body part restricting the flow direction of the refrigerant flowing in the expanded pipe;
an elastic member support part formed to extend from one end of the body part and supporting the elastic member; and
an extension part formed to extend from the elastic member support part and comprises an end movably coupled to the stopper, and
wherein the locking projection is formed to protrude outwardly from an outer circumferential surface of the end of the extension part.

8. The refrigerant piping system of claim 7, wherein the elastic member support part has a diameter smaller than a diameter of the body part, and the extension part has a diameter smaller than the diameter of the elastic member support part.

9. The refrigerant piping system of claim 7, wherein the stopper is formed in a shape of fan blades, wherein the check valve further comprises:
a refrigerant passage opening formed between the fan blades to allow the refrigerant to pass through the refrigerant passage opening;
a coupling hole formed in a central portion of the stopper into which an end of the extension part is movably inserted, wherein the locking slit is formed to extend from the coupling hole.

10. The refrigerant piping system of claim 7, wherein the valve body further comprises:
a sealing member coupled on the body part and preventing the refrigerant existing in the first refrigerant pipe from leaking when the first refrigerant pipe is closed by operation of the valve body, and
wherein the body part has a sealing member coupling groove concavely formed on an outer circumferential surface of the body part to accommodate the sealing member.

11. The refrigerant piping system of claim 7, wherein a front end of the body part is installed in close contact with a discharge port of the first refrigerant pipe.

12. The refrigerant piping system of claim 6, wherein the second side of the second refrigerant pipe is inserted into the side of the expanded pipe and fixed to a rear surface of the stopper so as to limit movement of the stopper in the expanded pipe.

13. A method for assembling a refrigerant piping system comprising:
a first refrigerant pipe connected to a compressor;
an expanded pipe formed to extend from one end of the first refrigerant pipe; and
a second refrigerant pipe comprising: a first side connected to a condenser; and a second side inserted into and fixed to a side of the expanded pipe, the method comprising:
assembling a check valve comprising a valve body; a stopper coupled to a rear end of the valve body; and an elastic member disposed between the valve body and the stopper;
disposing the check valve inside the expanded pipe;
inserting and coupling a side of the second refrigerant pipe into and to a side of the expanded pipe in which the check valve is disposed; and
fixing the side of the second refrigerant pipe and the side of the expanded pipe by welding.

14. The method of claim 13, wherein the assembling the check valve comprises:
coupling the elastic member to the valve body;
inserting the rear end of the valve body comprising a locking protrusion into the stopper comprising a coupling hole and a locking slit; and
rotating the stopper in one direction such that the locking protrusion is released from the locking slit and comes into contact with a rear surface of the stopper, whereby the valve body, the elastic member, and the stopper are completely assembled in an integral form.
